(19) United States
(12) Patent Application Publication
(10) Pub. No.: US 2015/0134971 A1
(43) Pub. Date: May 14, 2015

(54) APPARATUS AND METHOD FOR DECRYPTING ENCRYPTED FILE

(71) Applicant: ELECTRONICS AND TELECOMMUNICATIONS RESEARCH INSTITUTE, Daejeon (KR)

(72) Inventors: Jung Youl PARK, Daejeon (KR); Hyeonjin KIM, Daejeon (KR); Dong Hoon LEE, Daejeon (KR)

(21) Appl. No.: 14/465,495

(22) Filed: Aug. 21, 2014

(30) Foreign Application Priority Data
Nov. 8, 2013 (KR) 10-2013-0135631

(51) Int. Cl. G06F 21/62; H04L 9/08; G06F 21/60

(52) U.S. Cl. CPC G06F 21/6218; G06F 21/602; H04L 9/0861
USPC 713/189

(57) ABSTRACT

An apparatus and method for decrypting an encrypted MS Office file using a key other than a password used for encryption, based on a time-memory trade-off (TMTO) technique. The apparatus for decrypting an encrypted file includes a table generation unit for generating a table corresponding to an encryption algorithm used in an encrypted file. A data extraction unit extracts an encryption header from the encrypted file, and extracts encrypted fixed plaintext of a block corresponding to the extracted encryption header. A data search unit generates a key chain based on the encrypted fixed plaintext, generates final key candidates corresponding to the generated key chain, and searches for a start key using the final key candidates and the table. A key verification unit verifies validity of an encryption key using the start key. A reencryption unit reencrypts the encrypted file using the encryption key.

### CROSS REFERENCE TO RELATED APPLICATION

This application claims the benefit of Korean Patent Application No. 10-2013-0135631, filed on Nov. 8, 2013, which is hereby incorporated by reference in its entirety into this application.

### BACKGROUND OF THE INVENTION

1. Technical Field

The present invention relates generally to an apparatus and method for decrypting an encrypted file and, more particularly, to an apparatus and method that decrypt an encrypted Microsoft (MS) Office file using a key other than a password used for encryption, based on a time-memory trade-off (TMTO) technique.

2. Description of the Related Art

Among files having various formats for storing documents, Microsoft Office (MS Office) files occupy a large portion.

In the case of MS Office, the 2013 version of MS Office has been released and is currently in use. However, for compatibility with low specification Personal Computers (PCs) using previous versions, a considerable number of files stored in the format of versions previous to MS Office 2000 are still present. MS Office files of versions previous to MS Office 2000 may be encrypted using a unique encryption algorithm and then stored. In this case, since it is difficult to find design vulnerabilities in a basic algorithm used at this time, a method of decrypting ciphertext using password searching is known as the most efficient attack method in practice.

As methods of detecting passwords from ciphertext of an encryption algorithm, the vulnerabilities of which are not known, there are two types of well-known methods, that is, a dictionary-based attack method which investigates the dictionary of known passwords or passwords derived from the known passwords, and a complete enumeration attack method which investigates all possible combinations of passwords.

For example, Korean Patent Application Publication No. 10-2010-0098094 entitled “System and method for recovering passwords from MS Office files at high speed using a graphic processor” discloses technology for rapidly verifying, in parallel, whether the candidate password of an MS Office file which is encrypted with a password set in the MS Office file is a correct password by using a graphic processor, thus recovering the password.

Such a dictionary-based attack method is disadvantageous in that when a password used for encryption is not a simply transformed version of a dictionary word, there is a strong possibility to fail in recovery. The complete enumeration attack method is disadvantageous in that a computational load is excessively large. For example, when the complete enumeration attack method is used for a case where all 95 letters including the capital letters and small letters of the English alphabet, numerals, and special symbols are used and a length is 9, possible combinations of passwords are given as 95⁹≈2⁵⁹ types, and thus it is realistically difficult to search for passwords. Therefore, when complicated passwords are used, other attack methods are required.

Attack methods differing from the above two attack methods include a password search attack method using a time-memory trade-off (TMTO) technique. Such a password search attack method corresponds to an attack method proposed as a compromise between an attack method of investing time (for example, the complete enumeration attack method) and an attack method dependent on memory (storage space) (for example, a method of generating a ciphertext table for all passwords, searching the table for ciphertext, and directly reading the corresponding password).

The password search attack method using a TMTO technique is a method of transforming only ciphertext of some passwords selected in conformity with a special rule, according to a specific rule, storing the transformed ciphertext in the form of a table, searching the table for the ciphertext or the transformation thereof, and inversely calculating an original password.

Such a TMTO technique is known as being highly efficient, but is disadvantageous in that it is applicable only when original plaintext of ciphertext has a specific format.

### SUMMARY OF THE INVENTION

Accordingly, the present invention has been made keeping in mind the above problems occurring in the prior art, and an object of the present invention is to provide an apparatus and method that decrypt an encrypted MS Office file using a key other than a password used for encryption, based on a TMTO technique.

In accordance with an aspect of the present invention to accomplish the above object, there is provided an apparatus for decrypting an encrypted file, including a table generation unit for generating a table corresponding to an encryption algorithm used in an encrypted file; a data extraction unit for extracting an encryption header from the encrypted file, and extracting encrypted fixed plaintext of a block corresponding to the extracted encryption header; a data search unit for generating a key chain based on the encrypted fixed plaintext, generating final key candidates corresponding to the generated key chain, and searching for a start key using the final key candidates and the table; a key verification unit for verifying validity of an encryption key using the start key; and a reencryption unit for reencrypting the encrypted file using the encryption key.

The encrypted file may correspond to an encrypted Microsoft (MS) Office file, and may be generated by encrypting an MS Office file using a 40-bit Rivest Cipher 4 (RC4) algorithm or a Cryptographic Application Programming Interface RC4 (CryptoAPI RC4) algorithm used in versions previous to MS Office 2000.

The table generation unit may include a selection unit for selecting a reduction function depending on an encryption algorithm corresponding to the encrypted file; a key chain generation unit for generating a key chain based on the reduction function, and calculating a start key and a final key based on the generated key chain; and a generation unit for generating a table depending on the encryption algorithm using the start key and the final key.

The generation unit may include at least one of a table for a 40-bit RC4 algorithm used in MS Word and MS Excel files, a table for a CryptoAPI RC4 algorithm used in MS PowerPoint files and for blocks that use a block number 0 (BlockNum 0), and a table for the CryptoAPI RC4 algorithm used in MS PowerPoint files and for blocks other than the blocks that use BlockNum 0.

The key chain generation unit may generate a key chain having a form of a rainbow key chain.

The data extraction unit may include an encryption header extraction unit for extracting an encryption header required to verify a password used for encryption from the received encrypted file; and a plurality of fixed plaintext extraction units for extracting the encrypted fixed plaintext depending on an encryption algorithm corresponding to the encrypted file.

The key verification unit may include a key chain generation unit for re-generating a key chain using a start key found by the data search unit; and a determination unit for determining whether the encrypted fixed plaintext is present among key values included in the key chain re-generated by the key chain generation unit, and transferring an encryption key to the reencryption unit according to, a principle of a time-memory trade-off (TMTO) technique if it is determined that the encrypted fixed plaintext is present.

The reencryption unit may include a header reencryption unit for reconstructing an encryption header extracted from the encrypted file; a block decryption unit for decrypting each encrypted block using the encryption key received from the key verification unit; and a block reencryption unit for reencrypting each block decrypted by the block decryption unit using the encryption key used in the reconstructed encryption header.

In accordance with another aspect of the present invention to accomplish the above object, there is provided a method of decrypting an encrypted file, including generating a table corresponding to an encryption algorithm used in an encrypted file; extracting an encryption header from the encrypted file, and extracting encrypted fixed plaintext of a block corresponding to the extracted encryption header; generating a key chain based on the encrypted fixed plaintext, generating final key candidates corresponding to the generated key chain, and searching for a start key using the final key candidates and the table; verifying validity of an encryption key using the start key; and reencrypting the encrypted file using the encryption key.

Generating the table may be configured such that the encrypted file corresponds to an encrypted Microsoft (MS) Office file, and may be configured to generate a table corresponding to an encryption algorithm used in a file encrypted using a 40-bit Rivest Cipher 4 (RC4) algorithm or a Cryptographic Application Programming Interface RC4 (CryptoAPI RC4) algorithm used in versions previous to MS Office 2000.

Generating the table may include selecting a reduction function depending on an encryption algorithm corresponding to the encrypted file; generating a key chain based on the reduction function, and calculating a start key and a final key based on the generated key chain; and generating a table depending on the encryption algorithm using the start key and the final key.

Generating the table depending on the encryption algorithm using the start key and the final key may include generating at least one of a table for a 40-bit RC4 algorithm used in MS Word and MS Excel files, a table for a CryptoAPI RC4 algorithm used in MS PowerPoint files and for blocks that use a block number 0 (BlockNum 0), and a table for the CryptoAPI RC4 algorithm used in MS PowerPoint files and for blocks other than the blocks that use BlockNum 0.

Extracting the encrypted fixed plaintext may include extracting an encryption header required to verify a password used for encryption from the received encrypted file; and extracting the encrypted fixed plaintext depending on an encryption algorithm corresponding to the encrypted file.

Reencrypting the encrypted file may include reconstructing an encryption header extracted from the encrypted file; decrypting each encrypted block using an encryption key, validity of which has been verified; and reencrypting each decrypted block using the encryption key used in the reconstructed encryption header.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically showing an apparatus for decrypting an encrypted file according to an embodiment of the present invention;

FIG. 2 is a configuration diagram showing a table generation unit according to an embodiment of the present invention;

FIG. 3 is a diagram showing a key chain generation unit according to an embodiment of the present invention;

FIG. 4 is a diagram showing a generation unit according to an embodiment of the present invention;

FIG. 5 is a configuration diagram showing a data extraction unit according to an embodiment of the present invention;

FIG. 6 is a configuration diagram showing a data search unit according to an embodiment of the present invention;

FIG. 7 is a configuration diagram showing a key verification unit according to an embodiment of the present invention;

FIG. 8 is a configuration diagram showing a reencryption unit according to an embodiment of the present invention; and

FIG. 9 is a flowchart showing a method of decrypting an encrypted file according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, an apparatus and method for decrypting an encrypted Microsoft (MS) Office file using a key other than a password used for encryption, based on a time-memory trade-off (TMTO) technique, according to preferred embodiments of the present invention will be described in detail with reference to the attached drawings.

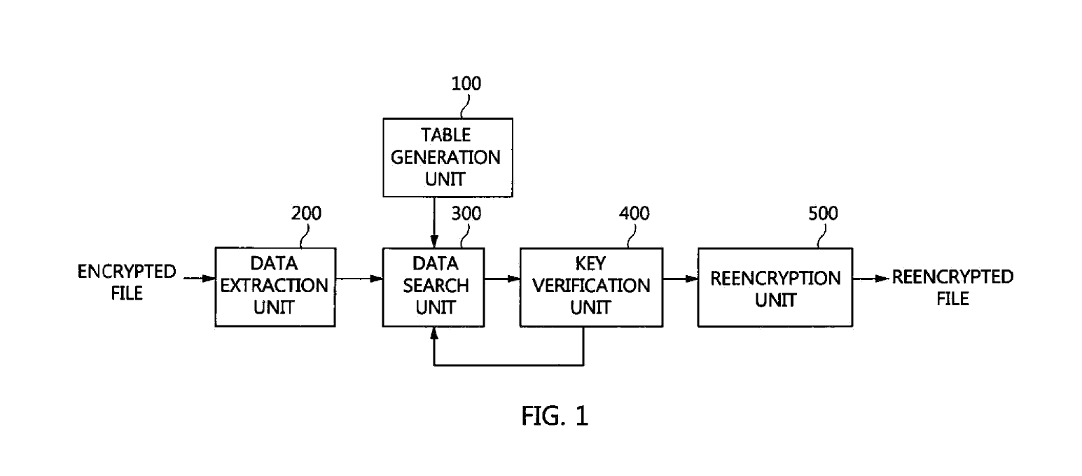

FIG. 1 is a configuration diagram schematically showing an apparatus for decrypting an encrypted file according to an embodiment of the present invention.

Referring to FIG. 1, an apparatus for decrypting an encrypted file includes a table generation unit 100, a data extraction unit 200, a data search unit 300, a key verification unit 400, and a reencryption unit 500.

The table generation unit 100 generates a TMTO table corresponding to an encryption algorithm used for an MS Office file (for example, MS Word, MS Excel, or MS PowerPoint files).

The data extraction unit 200 extracts an encryption header from an encrypted file, and extracts encrypted fixed plaintext of a block corresponding to the extracted encryption header. In this case, the encrypted file corresponds to the encrypted MS Office file.

The data search unit 300 generates a key chain based on the encrypted fixed plaintext, generates final key candidates corresponding to the key chain, and searches for a start key using the final key candidates and the TMTO table.

The key verification unit 400 verifies the validity of the key using the encryption header based on the results of the search conducted by the data search unit 300.

In detail, the key verification unit 400 generates a key chain from the start key found by the data search unit 300, and determines whether encrypted fixed plaintext is present in the generated key chain. In this case, if the encrypted fixed plaintext is not present in the key chain, the key verification unit 400 determines that the results of the search conducted by the data search unit 300 are wrong. In contrast, if the encrypted fixed plaintext is present in the key chain, the key verification unit 400 transfers an encryption key to the reencryption unit 500 because a key value, immediately previous to the found key, is the encryption key according to the principle of the time-memory trade-off (TMTO) technique.

The reencryption unit 500 reencrypts the encrypted file using the key verified by the key verification unit 400, that is, the encryption key.

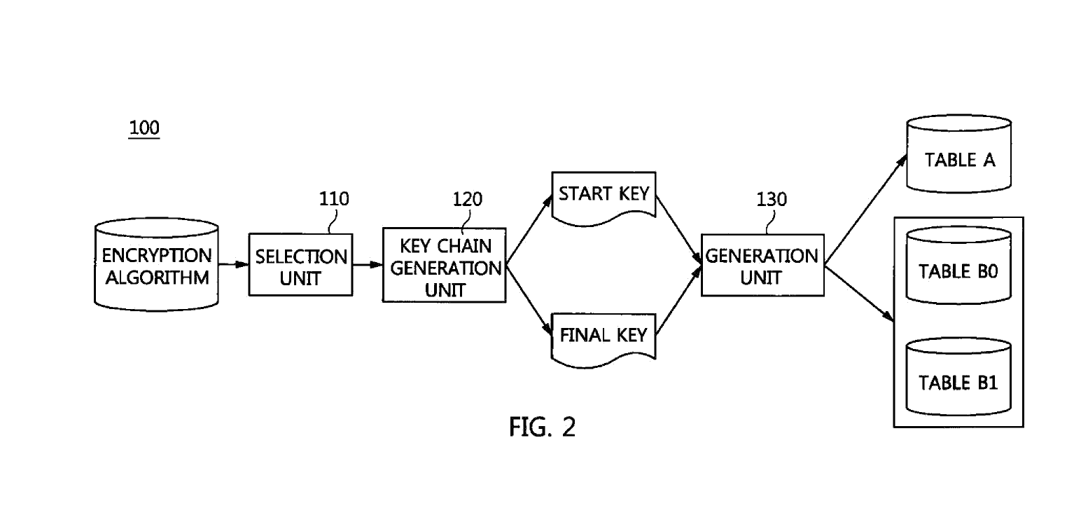

Below, the table generation unit 100 of the encrypted file decryption apparatus will be described in detail with reference to FIG. 2.

FIG. 2 is a configuration diagram showing the table generation unit according to an embodiment of the present invention.

Referring to FIG. 2, the table generation unit 100 includes a selection unit 110, a key chain generation unit 120, and a generation unit 130.

The selection unit 110 selects one of two types of reduction functions depending on the encryption algorithm used in versions previous to MS Office 2000.

The key chain generation unit 120 generates a key chain based on the reduction function selected by the selection unit 110, and calculates the start key and the final key of the generated key chain based on the key chain. Here, the key chain generated by the key chain generation unit 120 has the form of a rainbow key chain.

The generation unit 130 generates tables depending on the encryption algorithm using the start key and the final key. In this case, the generation unit 130 generates table A (total of one type) or tables B0 and B1 (total of two types) depending on the encryption algorithm.

The table A corresponds to a table for a 40-bit Rivest Cipher 4 (RC4) algorithm used in MS Word and MS Excel files.

The table B0 corresponds to a table for a Cryptographic Application Programming Interface (CryptoAPI) RC4 algorithm used in MS PowerPoint files, and is a table for blocks which use a block number 0 (BlockNum 0).

The table B1 corresponds to a table for the CryptoAPI RC4 algorithm and is a table for blocks other than the blocks which use BlockNum 0.

When each table is generated, the length of a chain NCOL to be used by the key chain generation unit 120 and the number of rows NROW of the generated table must satisfy the condition given by the following Equation (1):

NCOL*NROW=2⁴⁰ (1)

The reduction function selected by the selection unit 110 is a function for receiving 8 bytes or 12 bytes corresponding to the output of the RC4 encryption algorithm, extracting some bits from the output bytes, and outputting a total of 40 bits (5 bytes).

Which bits are to be extracted from the reduction function selected by the selection unit 110 is determined depending on details obtained by analyzing the content of documents related to an encryption method used in versions previous to MS Office 2000 originated by U.S. Microsoft. This determination is characterized in that bits at positions, the values of which are always fixed, in the first 8 bytes or the first 12 bytes of each data block constituting an MS Office document file, are fetched.

For such positions, a total of one set is present when the encryption algorithm used in MS Office files is the 40-bit RC4 algorithm, and a total of two sets are present when the encryption algorithm is the CryptoAPI RC4 algorithm, and thus as many reduction functions as the number of sets are present. Consequently, the number of types of tables that are generated is one or two.

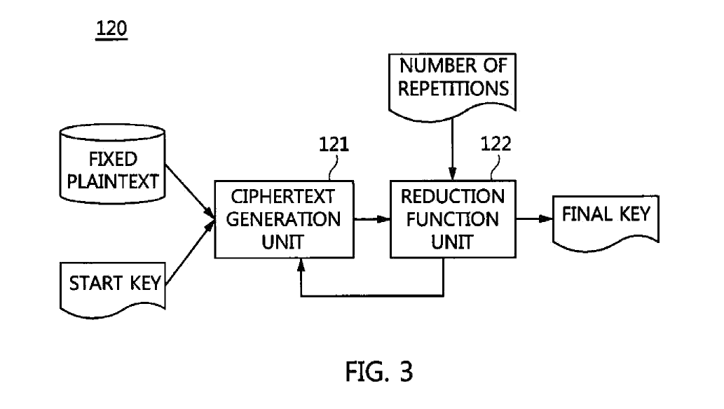

Below, the key chain generation unit 120 of the table generation unit 100 will be described in detail with reference to FIG. 3.

FIG. 3 is a diagram showing the key chain generation unit according to an embodiment of the present invention.

Referring to FIG. 3, the key chain generation unit 120 includes a ciphertext generation unit 121 and a reduction function unit 122.

First, the key chain generation unit 120 receives any start key having a length of 40 bits (5 bytes) and fixed plaintext having a length of 8 or 12 bytes, and initiates the corresponding operation. In this case, the specific positions of the fixed plaintext must be fixed at specific values, and the corresponding positions and values thereof must be identical to the positions and values of bits that are specified depending on the open documents of Microsoft and that are collected by the reduction function unit 122.

The ciphertext generation unit 121 generates ciphertext having a length of 8 bytes or 12 bytes by applying the RC4 encryption algorithm to the received start key and to the fixed plaintext.

The reduction function unit 122 outputs a result of 5 bytes by applying the ciphertext generated by the ciphertext generation unit 121 to the reduction function selected by the selection unit 110. Here, the result may be set to a new key, and a result obtained by repeating the procedure NCOL times is set to the final key.

That is, the reduction function unit 122 sets the result, obtained by applying the ciphertext generated by the ciphertext generation unit 121 to the reduction function a preset number of repetitions, to the final key.

The key chain generation unit 120 according to the embodiment of the present invention may apply the transformation of recognizing the output result as a 40-bit integer and of using the result of adding the number of repetitions to the integer, but the present invention is not limited to such a structure.

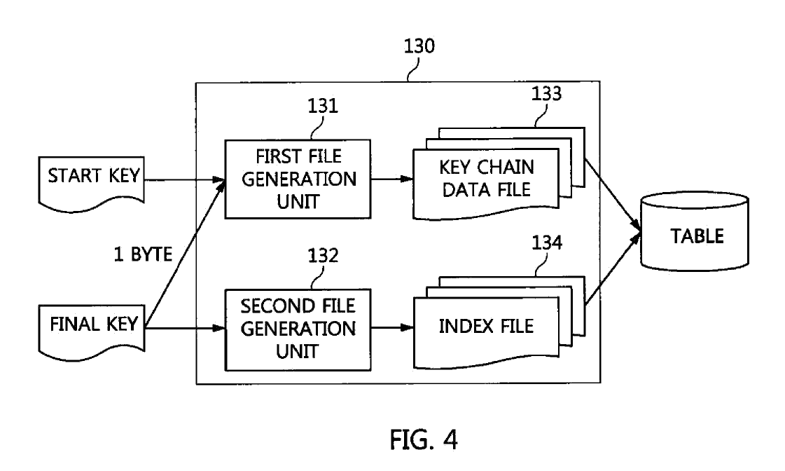

Below, the generation unit 130 of the table generation unit 100 will be described in detail with reference to FIG. 4.

FIG. 4 is a diagram showing the generation unit according to an embodiment of the present invention.

Referring to FIG. 4, the generation unit 130 receives a pair of a start key and a final key from the key chain generation unit 120.

The generation unit 130 includes a first file generation unit 131 and a second file generation unit 132.

The first file generation unit 131 extracts the start key having a length of 5 bytes and lower 1 byte of the final key, generates storage data of a total of 6 bytes, and generates key chain data files 133 by aligning and combining the 6-byte storage data based on the final key.

The second file generation unit 132 extracts upper 3 bytes of the final key having a length of 5 bytes, calculates an index, and generates index files 134.

The files generated by the generation unit 130 according to the embodiment of the present invention, that is, the key chain data files 133 and the index files 134, correspond to tables.

In this way, it is sufficient to perform the procedure for generating the tables in the table generation unit 100 only once when the encrypted file decryption apparatus is applied. However, when the procedure is performed once, a plurality of tables may be generated.

In the table generation unit 100 according to an embodiment of the present invention, if the length of the key chain is set to NCOL=5500, the size of one table may be about 1.2 G.

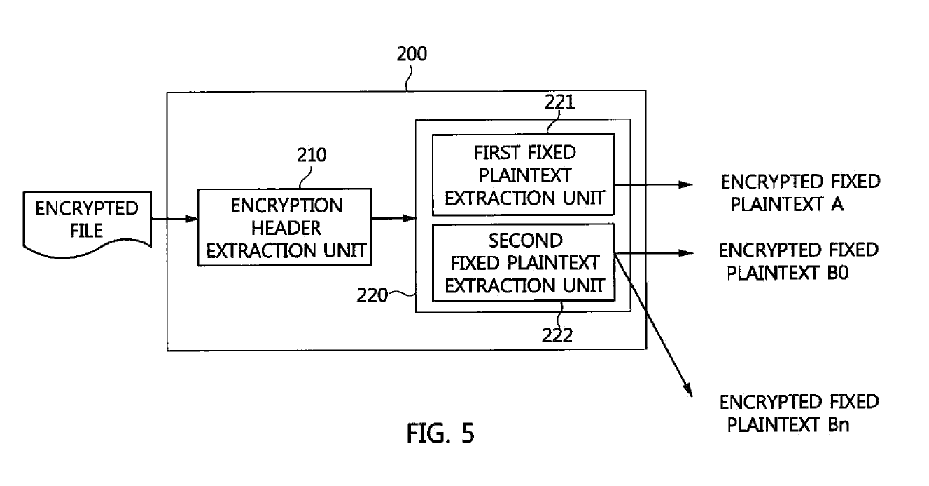

Below, the data extraction unit 200 of the encrypted file decryption apparatus will be described in detail with reference to FIG. 5.

FIG. 5 is a configuration diagram showing the data extraction unit according to an embodiment of the present invention.

First, the data extraction unit 200 receives an encrypted file, for example, an encrypted MS Office file (=encrypted file of FIG. 5).

Referring to FIG. 5, the data extraction unit 200 includes an encryption header extraction unit 210 and a fixed plaintext extraction unit 220.

The encryption header extraction unit 210 extracts three values, that is, Salt, EncryptedVerifier, and EncryptedVerifierHash, required to verify the password used for encryption from the received encrypted file E.

The encrypted file according to an embodiment of the present invention is encrypted in such a way as to encrypt each block constituting the file in accordance with the number of the corresponding block (BlockNum), based on the RC4 algorithm by using an encryption key derived from a password and a randomly designated Salt rather than using the password. Further, encryption key verification values, that is, EncryptedVerifier and EncryptedVerifierHash, are recorded in the file, together with Salt used.

When the user enters the password so as to decrypt the file, an encryption key is derived from the entered password and the Salt so as to verify the validity of the password, and the encryption key is verified using the EncryptedVerifier and the EncryptedVerifierHash values.

A procedure for deriving the encryption key from the password and the Salt slightly differs depending on whether a 40-bit RC4 algorithm or a CryptoAPI RC4 algorithm has been used as the encryption algorithm.

The fixed plaintext extraction unit 220 includes a first fixed plaintext extraction unit 221 and a second fixed plaintext extraction unit 222.

The first fixed plaintext extraction unit 221 and the second fixed plaintext extraction unit 222 extract encrypted fixed plaintext having a length of 40 bits (5 bytes) from first 8 bytes or 12 bytes of each encrypted block constituting the encrypted file in accordance with encryption in which the 40-bit RC4 algorithm is used and encryption in which the CryptoAPI RC4 algorithm is used, respectively.

A method of extracting encrypted fixed plaintext in the fixed plaintext extraction unit 220 is similar to a method of extracting 40 bits (5 bytes) at specific positions from fixed plaintext by using a reduction function, as shown in FIG. 3.

If the 40-bit RC4 algorithm is used, it is sufficient to extract a single encrypted fixed plaintext block (encrypted fixed plaintext A of FIG. 5) from blocks that use BlockNum 0 through the first fixed plaintext extraction unit 221.

In contrast, if the CryptoAPI RC4 algorithm is used, encrypted fixed plaintext blocks (encrypted fixed plaintext B0˜encrypted fixed plaintext Bn of FIG. 5) must be extracted, for all block numbers, from blocks having the corresponding block number (BlockNum) through the second fixed plaintext extraction unit 222. Therefore, if the CryptoAPI RC4 algorithm is used, the number of encrypted fixed plaintext blocks to be extracted is identical to, the number of encrypted blocks constituting the encrypted file.

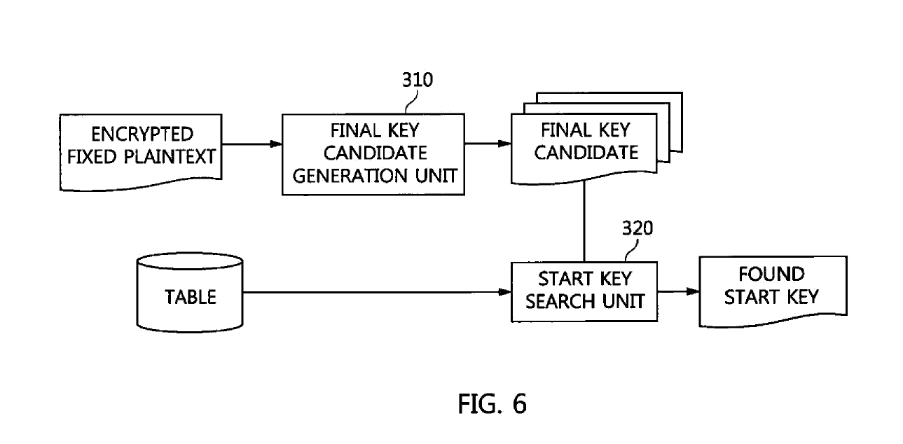

Next, the data search unit 300 of the encrypted file decryption apparatus will be described in detail with reference to FIG. 6.

FIG. 6 is a configuration showing the data search unit according to an embodiment of the present invention.

Referring to FIG. 6, the data search unit 300 includes a final key candidate generation unit 310 and a start key search unit 320.

The final key candidate generation unit 310 generates NCOL final key candidates by generating NCOL key chains using the encrypted fixed plaintext.

In detail, the final key candidate generation unit 310 receives the encrypted fixed plaintext extracted by the data extraction unit 200, and performs the following procedure for each encrypted fixed plaintext block.

Since each encrypted fixed plaintext (block) has a 40-bit (5-byte) length, it is treated as a start key used by the key chain generation unit 120 shown in FIG. 3, and NCOL final keys are obtained by setting the number of repetitions of a procedure for applying the RC4 encryption algorithm and the reduction function in such a way as to perform and terminate the procedure 0 time, perform and terminate the procedure once, and, . . . , perform and terminate the procedure (NCOL−1) times. The NCOL final keys acquired through the above procedure correspond to final key candidates shown in FIG. 6. In this procedure, a transformation, such as a method of using the result obtained by adding the number of repetitions in the description made in relation to the key chain generation unit 120, is based on the transformed values other than the number of repetitions. For example, when there are final keys obtained by performing and terminating the procedure three times, a total of three reduction function application procedures must be undergone upon calculating the final keys. A transformation applied to the first reduction function unit 122 corresponds to (NCOL−2), a transformation applied to the second reduction function unit corresponds to (NCOL−1), and a transformation applied to the third reduction function unit corresponds to NCOL, and thus the transformation of the reduction function which the corresponding final key finally passes through in the calculation procedure is a transformation corresponding to NCOL.

Next, the start key search unit 320 searches the table generated by the table generation unit 100 for final key candidates generated by the final key candidate generation unit 310, and finds start keys corresponding to the final key candidates.

As described above with reference to FIG. 4, the table includes each index file 134 composed of upper 3 bytes of each final key, and each key chain data file 133 in which pieces of storage data composed of each start key and upper 1 byte of the final key are aligned based on the final key.

Therefore, the start key search unit 320 searches the index file 134 for the upper 3 bytes of each final key candidate, searches the corresponding range of the key chain data file 133 corresponding to the searched index file for storage data having a value identical to the lower 1 byte of each final key. If the search has succeeded, start keys corresponding to the respective final key candidates may be found.

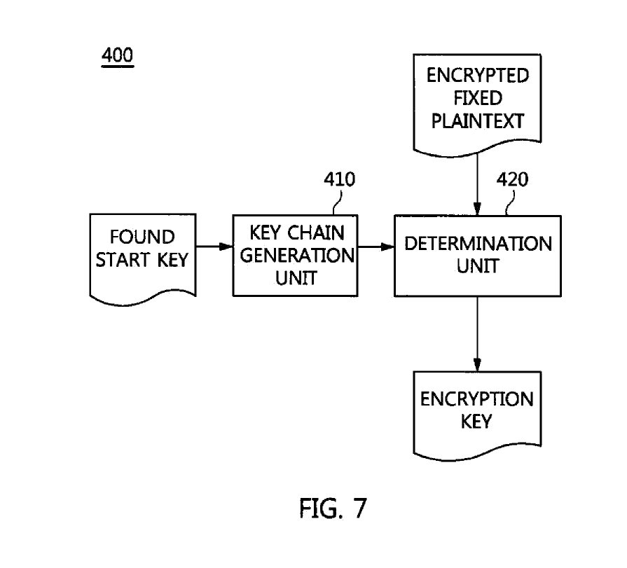

Below, the key verification unit 400 of the encrypted file decryption apparatus will be described in detail with reference to FIG. 7.

FIG. 7 is a configuration diagram showing the key verification unit according to an embodiment of the present invention.

Referring to FIG. 7, the key verification unit 400 includes a key chain generation unit 410, and a determination unit 420.

The key chain generation unit 410 generates a key chain using the same operation as that of the key chain generation unit 120 of FIG. 2, but outputs all of (NCOL−1) key values having a length of 40 bits (5 bytes) obtained during a procedure for receiving a start key found by the data search unit 300 and calculating a final key.

The determination unit 420 determines whether encrypted fixed plaintext extracted from an initially encrypted file is present among a total of NCOL key values obtained by adding the final key corresponding to the start key found by the data search unit 300 to the (NCOL−1) key values output from the key chain generation unit 410.

If it is determined by the determination unit 420 that encrypted fixed plaintext is not present, the start key search unit 320 must search for another start key.

If it is determined by the determination unit 420 that the encrypted fixed plaintext is present, an encryption key is transferred to the reencryption unit 500 because a key immediately previous to the corresponding start key is the encryption key according to the principle of the TMTO technique.

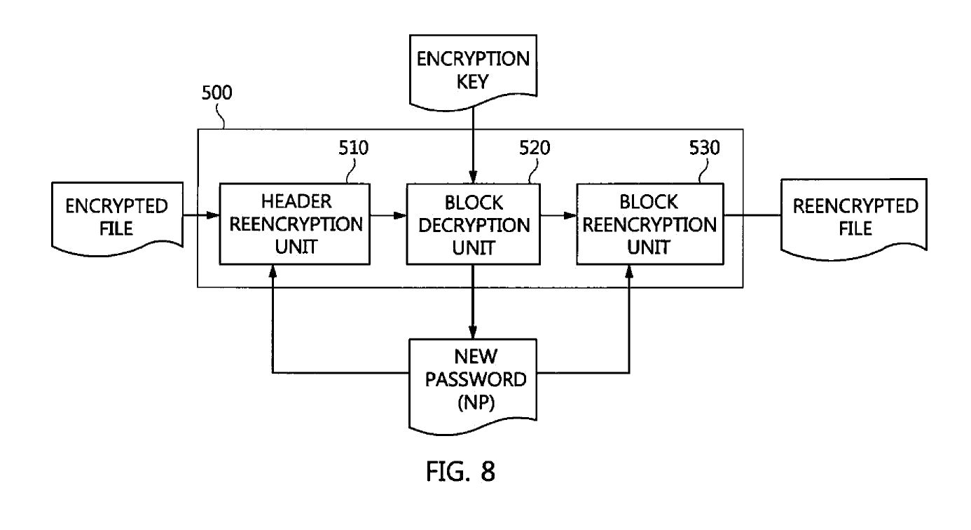

Below, the reencryption unit 500 of the encrypted file decryption apparatus will be described in detail with reference to FIG. 8.

FIG. 8 is a configuration diagram showing the reencryption unit according to an embodiment of the present invention.

Referring to FIG. 8, the reencryption unit 500 includes a header reencryption unit 510, a block decryption unit 520, and a block reencryption unit 530.

The header reencryption unit 510 reconstructs an encryption header extracted from a received encrypted file E. That is, the header reencryption unit 510 transforms values, such as Salt, Encrypted Verifier, and EncryptedVerifierHash extracted by the encryption header extraction unit 210, in accordance with a new encryption key derived from a new password (NP), that is, the encryption key received from the determination unit 420.

The header reencryption unit 510 may or may not change Salt extracted by the encryption header extraction unit 210, and may use a value derived from a pre-designated password such as “1234”, which is easy to remember, using an encryption algorithm as the new encryption key. However, the encryption key is not limited to such a specific value.

The block decryption unit 520 decrypts each encrypted block using the encryption key transferred from the determination unit 420.

If the 40-bit RC4 algorithm is used for the encryption of an MS Office file, all blocks may be decrypted using a single encryption key, whereas if the CryptoAPI RC4 algorithm is used, different encryption keys are required for encrypted blocks having different block numbers (BlockNum). Therefore, in this case, the data search unit 300 and the key verification unit 400 must search for encryption keys corresponding to all block numbers (BlockNum).

That is, the block decryption unit 520 takes over the encryption keys corresponding to block numbers (BlockNum), and decrypts the individual blocks of the encrypted file.

The block reencryption unit 530 reencrypts the blocks decrypted by the block decryption unit 520 using a new password (NP) used by the header reencryption unit 510 and encryption keys derived from the NP. In this case, if the password is known, encryption keys required for all block numbers (BlockNum) may be derived, and thus there is no difference between the two algorithms from the standpoint of the block reencryption unit 530. If all blocks are newly encrypted and then stored as a single file, the file may be an MS Office file that can be decrypted using the new password NP, thus allowing the user to check the content of the MS Office file.

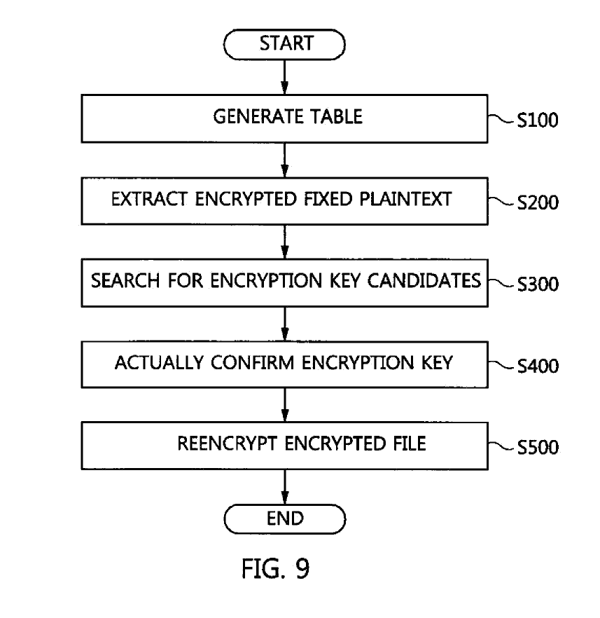

Hereinafter, a method for decrypting an encrypted file will be described in detail with reference to FIG. 9.

FIG. 9 is a flowchart showing a method for decrypting an encrypted file according to an embodiment of the present invention.

Referring to FIG. 9, the table generation unit 100 of the encrypted file decryption apparatus generates a TMTO table corresponding to an encryption algorithm used for an MS Office file (for example, MS Word, MS Excel, or MS PowerPoint files) at step S100.

The data extraction unit 200 of the encrypted file decryption apparatus extracts an encryption header from the encrypted file, and extracts encrypted fixed plaintext of a block corresponding to the extracted encryption header at step S200.

The data search unit 300 of the encrypted file decryption apparatus generates a key chain based on the encrypted fixed plaintext, generates final key candidates corresponding to the key chain, and searches for a start key using the final key candidates and the TMTO table at step S300.

The key verification unit 400 of the encrypted file decryption apparatus generates a key chain from the start key found at step S300, and determines whether encrypted fixed plaintext is present in the generated key chain at step S400.

If it is determined at step S400 that encrypted fixed plaintext is not present in the key chain, it is determined that the start key found at step S300 is a wrong key, and a start key must be searched for again at step S300.

In contrast, if it is determined that the encrypted fixed plaintext is present in the key chain, an encryption key is applied to a subsequent step because a key value immediately previous to the found start key is the encryption key according to the principle of the TMTO technique.

The reencryption unit 500 of the encrypted file decryption apparatus reencrypts the encrypted file, using the key verified at step S400, that is, the encryption key, at step S500.

In this way, the encrypted file decryption apparatus according to embodiments of the present invention may obtain the effect of indirectly decrypting an encrypted file by searching for the key of the file encrypted using an encryption algorithm used by MS Office files of versions previous to MS Office 2000 and by encrypting the file using a pre-agreed new password.

In accordance with the present invention, an apparatus and method for decrypting an encrypted file are advantageous in that they may obtain the effect of indirectly decrypting an encrypted file by searching for the key of the file encrypted using an encryption algorithm used by MS Office files of versions previous to MS Office 2000 and by encrypting the file using a pre-agreed new password. Further, during this procedure, the problem of conventional technology related to the requirement of a lot of time and a low success rate occurring upon using an existing password search method can be solved.

That is, the present invention enables files to be decrypted at high speed with higher success rate.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for decrypting an encrypted file, comprising:
a table generation unit for generating a table corresponding to an encryption algorithm used in an encrypted file;
a data extraction unit for extracting an encryption header from the encrypted file, and extracting encrypted fixed plaintext of a block corresponding to the extracted encryption header;
a data search unit for generating a key chain based on the encrypted fixed plaintext, generating final key candidates corresponding to the generated key chain, and searching for a start key using the final key candidates and the table;
a key verification unit for verifying validity of an encryption key using the start key; and
a reencryption unit for reencrypting the encrypted file using the encryption key.

2. The apparatus of claim 1, wherein the encrypted file corresponds to an encrypted Microsoft (MS) Office file, and is generated by encrypting an MS Office file using a 40-bit Rivest Cipher 4 (RC4) algorithm or a Cryptographic Application Programming Interface RC4 (CryptoAPI RC4) algorithm used in versions previous to MS Office 2000.

3. The apparatus of claim 1, wherein the table generation unit comprises:
a selection unit for selecting a reduction function depending on an encryption algorithm corresponding to the encrypted file;
a key chain generation unit for generating a key chain based on the reduction function, and calculating a start key and a final key based on the generated key chain; and
a generation unit for generating a table depending on the encryption algorithm using the start key and the final key.

4. The apparatus of claim 3, wherein the generation unit generates at least one of a table for a 40-bit RC4 algorithm used in MS Word and MS Excel files, a table for a CryptoAPI RC4 algorithm used in MS PowerPoint files and for blocks that use a block number 0 (BlockNum 0), and a table for the CryptoAPI RC4 algorithm used in MS PowerPoint files and for blocks other than the blocks that use BlockNum 0.

5. The apparatus of claim 3, wherein the key chain generation unit generates a key chain having a form of a rainbow key chain.

6. The apparatus of claim 1, wherein the data extraction unit comprises:
an encryption header extraction unit for extracting an encryption header required to verify a password used for encryption from the received encrypted file; and
a plurality of fixed plaintext extraction units for extracting the encrypted fixed plaintext depending on an encryption algorithm corresponding to the encrypted file.

7. The apparatus of claim 1, wherein the key verification unit comprises:
a key chain generation unit for re-generating a key chain using a start key found by the data search unit; and
a determination unit for determining whether the encrypted fixed plaintext is present among key values included in the key chain re-generated by the key chain generation unit, and transferring an, encryption key to the reencryption unit according to a principle of a time-memory trade-off (TMTO) technique if it is determined that the encrypted fixed plaintext is present.

8. The apparatus of claim 1, wherein the reencryption unit comprises:
a header reencryption unit for reconstructing an encryption header extracted from the encrypted file;
a block decryption unit for decrypting each encrypted block using the encryption key received from the key verification unit; and
a block reencryption unit for reencrypting each block decrypted by the block decryption unit using the encryption key used in the reconstructed encryption header.

9. A method of decrypting an encrypted file, comprising:
generating a table corresponding to an encryption algorithm used in an encrypted file;
extracting an encryption header from the encrypted file, and extracting encrypted fixed plaintext of a block corresponding to the extracted encryption header;
generating a key chain based on the encrypted fixed plaintext, generating final key candidates corresponding to the generated key chain, and searching for a start key using the final key candidates and the table;
verifying validity of an encryption key using the start key; and
reencrypting the encrypted file using the encryption key.

10. The method of claim 9, wherein generating the table is configured such that the encrypted file corresponds to an encrypted Microsoft (MS) Office file, and is configured to generate a table corresponding to an encryption algorithm used in a file encrypted using a 40-bit Rivest Cipher 4 (RC4) algorithm or a Cryptographic Application Programming Interface RC4 (CryptoAPI RC4) algorithm used in versions previous to MS Office 2000.

11. The method of claim 9, wherein generating the table comprises:
selecting a reduction function depending on an encryption algorithm corresponding to the encrypted file;
generating a key chain based on the reduction function, and calculating a start key and a final key based on the generated key chain; and
generating a table depending on the encryption algorithm using the start key and the final key.

12. The method of claim 11, wherein generating the table depending on the encryption algorithm using the start key and the final key comprises generating at least one of a table for a 40-bit RC4 algorithm used in MS Word and MS Excel files, a table for a CryptoAPI RC4 algorithm used in MS PowerPoint files and for blocks that use a block number 0 (BlockNum 0), and a table for the CryptoAPI RC4 algorithm used in MS PowerPoint files and for blocks other than the blocks that use BlockNum 0.

13. The method of claim 9, wherein extracting the encrypted fixed plaintext comprises:
extracting an encryption header required to verify a password used for encryption from the received encrypted file; and
extracting the encrypted fixed plaintext depending on an encryption algorithm corresponding to the encrypted file.

14. The method of claim 9, wherein reencrypting the encrypted file comprises:
reconstructing an encryption header extracted from the encrypted file;
decrypting each encrypted block using an encryption key, validity of which has been verified; and
reencrypting each decrypted block using the encryption key used in the reconstructed encryption header.
